(19) United States
(12) Patent Application Publication
(10) Pub. No.: US 2009/0073799 A1
(43) Pub. Date: Mar. 19, 2009

(54) Gaseous fluid mixing apparatus

(76) Inventors: Remi Bourlart, Montrichard (FR); Regine Weber-Rozenbaum, Chateauneuf Sur Loire (FR)

Correspondence Address: JACOBSON HOLMAN PLLC, 400 SEVENTH STREET N.W., SUITE 600, WASHINGTON, DC, 20004, US

(21) Appl. No.: 12/219,686

(22) Filed: Jul. 25, 2008

(30) Foreign Application Priority Data
Aug. 3, 2007 (FR) 07 05 704

(51) Int. Cl. B01F 13/02

(52) U.S. Cl. 366/107

(57) ABSTRACT

A device for mixing gaseous fluids such as air, made up of a tank having a central line and provided with inlet and outlet ducts arranged so as to create an upward swirling movement of the said fluid inside the said tank in order to ensure homogenous temperature at the outlet, characterised in that the said tank comprises at least one means for amplifying mixing, wherein that amplifying means or additional means for communication with the outside/inside of the said tank takes the form of at least one inlet duct that is co-linear with the central line of the said tank and arranged on the lower part of the tank. Advantageously, the said co-linear inlet duct comprises at least one means to partly obstruct its proximal end.

This invention relates to a gaseous fluid mixing device applicable to the areas of aeronautics and/or land transport and/or physics.

More particularly, this invention is intended to provide a low-pressure air mixing and distribution system for aircraft.

Generally, a mixing apparatus is made up of a mixing tank with four inlets in the lower part and several outlets in the upper part in relation to its central line.

This type of mixing apparatus is used to mix flows of hot air, for example from the cabin of the aircraft, with flows of cold air taken from outside the aircraft and then conditioned in respect of pressure and temperature, for example, in order to obtain homogenous ambient temperature air flows inside the cabin for air-conditioning, so as to provide a certain level of comfort inside the said aircraft.

More precisely, the air flow inlets of such devices are generally tangential to the wall of the tank in order to generate a swirling movement of the fluid inside the tank.

Mixing apparatuses are required to meet some specific and indispensable technical characteristics, such as the homogenous distribution of the temperature of the air delivered from its different outlets, minimum fluid head loss and low noise.

Further, the mixing apparatus must be able to maintain the working of its essential characteristics in the event of a failure of a fan located at the inlets and/or outlets or if one of its outlets is obstructed, for example.

US patent U.S. Pat. No. 4,517,813 relates to an aircraft cabin air conditioning system with an air mixing apparatus providing accelerated heat mixing of air flows and allowing the recovery of the water condensates and/or ice particles created due to the contact between hot and cold air flows.

European patent EP 0808273 discloses a system for feeding dehumidified air intended for aircraft cabin air conditioning comprising an air mixing apparatus, with a water separator, and an environmental control system to supply such air. The system includes hot air duct means arranged to make the warmer used air from the cabin, initially loaded with humidity, flow towards a mixing chamber, cold air duct means to make the conditioned air flow to the same mixing chamber, collection means to collect and remove the humidity from the chamber, manifold means to direct the dehumidified joined airstreams onto the cabin.

European patent EP 1188666 shows an aircraft air conditioning system and method that may be adapted to use in pressurized or unpressurized areas, defining a sealed partition between them. More specifically, the air-conditioning system has an aerodynamic shutoff valve and a mixing apparatus designed to swirl the air flow.

The drawbacks of current systems are related firstly to the flow regime inside the tank and secondly to their size.

That is because the known devices are bulky, sometimes noisy, and because of their geometric shape and the involved flow regimes, they lead to non negligible head loss, making it necessary to oversize the supply fans.

The device according to the invention eliminates the drawbacks of the prior art by offering a reduced size, at the same time ensuring high comfort for passengers and crew on board an aircraft, for example. The device according to the invention allows the optimisation of the air, temperature and acoustic performance of the low-pressure mixing chambers.

This invention is aimed at remedying the drawbacks mentioned above, and to that end, it consists in a device for mixing gaseous fluids such as air, comprising a tank with a central line and having inlet and outlet ducts arranged so as to create an upward swirling movement of the said fluid inside the tank in order to ensure homogenous temperature at the outlet, characterised in that the said tank has at least one means for amplifying the mixing of fluid.

The amplifying means is preferably placed in the lower part of the tank in a way that is co-linear or substantially co-linear with the central line of the said tank. In the description below, the words “lower” and “upper” are used as adjectives to qualify the parts of the tank that are located opposite each other along the larger extension of the tank, and will be placed accordingly in the vertical assembled position of the tank.

Advantageously, the said amplification means is at least one inlet duct comprising at least one means to partly shut its proximal end.

Indeed, the said partly obstructing means may be made up of part of the wall of the said duct or at least one distinct physical element.

More precisely, the said physical element is placed at the proximal end of the said inlet duct and may be located along a diameter and/or a chord and/or at least two distinct radial directions of the proximal end of the said inlet duct.

Alternatively, the said physical element may be placed over the entire length and/or height of the said duct.

Further, the said duct comprises at least one adjustable shutting means.

The mixing device according to the invention may have a cylindrical or rectangular or ovoid or spherical or trapezoidal tank.

Advantageously, the said tank comprises additional ancillary devices on the inside, such as a rake and/or a diaphragm and/or a fan and/or an accelerator.

The invention will be understood clearly in light of the description below, relating to illustrative examples of this invention that are not limitative in any way, by reference to the drawings enclosed, where:

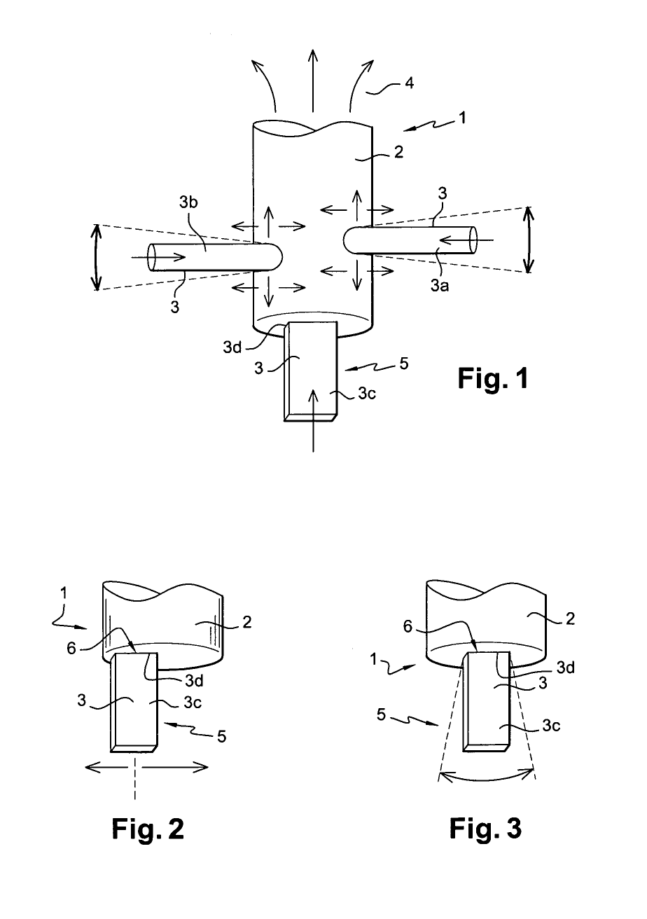

FIG. 1 is a partial schematic front representation of the device according to the invention;

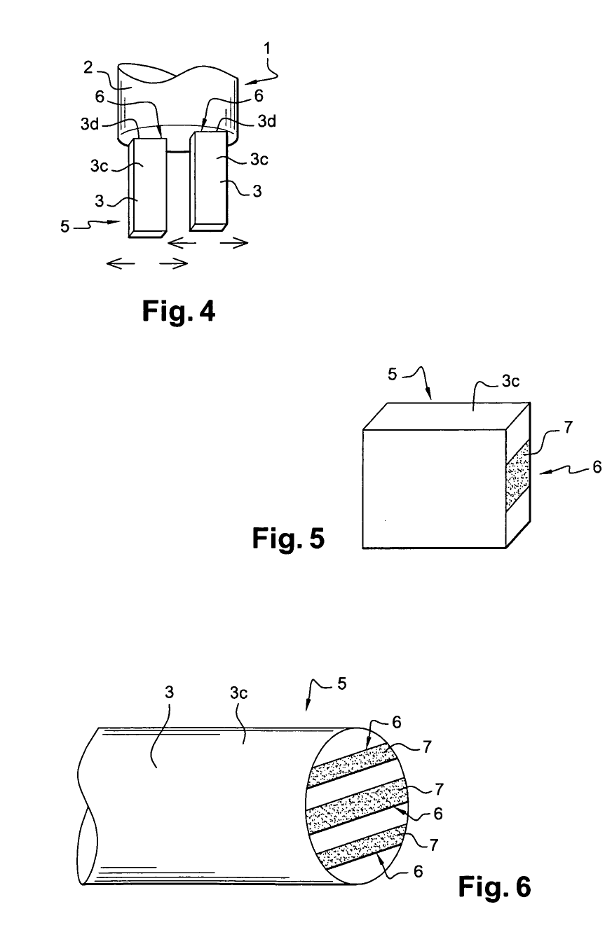

FIGS. 2 to 4 are partial front views of the device according to the invention;

FIGS. 5 and 6 are partial perspective views of an element of the said device according to the invention.

The device according to the invention relates to a mixing apparatus used to feed air to all the low-pressure systems of an aircraft, for example, while regulating the temperature homogeneity.

FIG. 1 is a partial schematic front representation of the device according to the invention.

A mixing apparatus 1 generally comprises a mixing tank 2, with a central line, provided with inlet and outlet ducts arranged so as to create a swirling movement inside the said tank.

Preferably, the tank 2 of the mixing apparatus according to the invention has flow inlets 3 in its lower part in relation to the central line and flow outlets 4 in its upper part arranged so as to create an upward swirling movement of the fluid inside the said tank in order to ensure an homogenous temperature at the outlet.

In that way, it makes it possible to mix:
at least one inlet duct 3a for hot air flow from an aircraft cabin, and
at least one inlet duct 3b for cold air flow taken from outside the aircraft and conditioned in respect of pressure and temperature,
in order to obtain air conditioning in the cabin and thus outlet ducts 4 for air flow at an homogenous room temperature.

In order to mix the incoming air flows in the best way, it is necessary to create a swirling movement of fluid inside the tank 2, and thus arrange the air flow inlet ducts 3 according to the movement of fluid required inside.

According to a preferred arrangement, some inlet ducts are substantially tangential to the wall of the said tank so as to create the said swirling movement.

Preferably, the inlet ducts may be arranged at an angle that ranges from tangential and perpendicular to the wall of the said tank.

Alternatively, the air flow inlet ducts 3 and outlet ducts 4 may have variable orientations (angle required in relation to the central line of the said tank).

Favourably, the inlet ducts 3 and the outlet ducts 4 are arranged at heights that are variable among themselves (inlet and inlet) and in relation to the others (inlet and outlets).

Preferably, the number, arrangement and geometry of the inlet ducts 3 and outlet ducts 4 are variable.

The inlet ducts 3 and/or the outlet ducts 4 may be symmetrical to each other in relation to the central line of the said tank 2.

Preferably, the tank 2 has the same number of air flow inlet ducts 3 on either side and for hot and cold air flows.

Alternatively, there may be an odd number of inlet ducts 3 on one side of the tank 2 and an even number on the other.

According to another arrangement, the said tank 2 may have hot air inlet ducts 3a on only one side and cold air inlet ducts 3b on the opposite side in relation to the central line.

The sections, diameters and dimensions of the orifices and inlet ducts 3 and outlet ducts 4 are also variable and depend on the required output of the said mixing apparatus 1.

All the inlet ducts 3 and outlet ducts 4 may be shut or their output regulated by at least one adjustable shutting means such as a valve or a plug or any other means of a type known in itself.

The said tank 2 is preferably cylindrical, but may also be rectangular, ovoid, spherical, trapezoidal, etc.

The quality of the flow regime and the temperature mixing achieved inside the said tank 2 depends on:
the direction and/or geometric characteristics of the inlet ducts 3 of the mixing apparatus according to the invention, and also the outlet ducts 4 of the mixing apparatus 1; and
the interaction between the movement of fluid inside the tank 2 of mixing apparatus 1 with stationary swirling structures located near the internal walls of the said mixing apparatus.

The device according to the invention makes it possible to optimise the size of a mixing apparatus that has or has not undergone geometrical modifications (dimensions and number of air flow inlet and outlet ducts).

The device according to the invention thus comprises a tank 2 provided with at least one fluid mixing amplification or optimisation or acceleration means 5, in order to reduce the size of the said tank and thus of the said mixing apparatus 1.

As illustrated in FIG. 1, the device according to the invention preferably comprises inlet ducts 3 that are tangent and horizontal to the wall of the tank 2.

FIGS. 2 to 4 are partial front views of the device according to the invention.

The said at least one means of amplification 5 of the fluid mixing is at least an additional means of communication towards the outside/inside of the said tank.

Advantageously, the said at least one additional means of communication 5 takes the form of at least one specific additional inlet duct 3c, located on the lower part of the said tank 2, in a way as to be co-linear or substantially co-linear, i.e. along the same line as the upward swirling flow, inside the said tank.

The terms substantially co-linear mean that the angular deviation of the said at least one specific inlet 3c in relation to the central line of the said tank is of one degree to several tens of degrees.

In that way, the said at least one co-linear air flow inlet duct 3c arranged at the bottom of the said tank 2 allows the entry of fluid in a way that is axial to the central line of the said tank.

As an illustrative example, the co-linear inlet duct 3c and the said tank are arranged vertically in relation to the central line of the said tank.

Advantageously, the said at least one co-linear air flow inlet duct 3c comprises at least one means 6 to partly obstruct or shut off the incoming air flow.

For example, more specifically, the said at least one co-linear air flow inlet duct 3c comprises at its proximal end, adapted to cooperate with an orifice 3d of the said tank 2 provided for that purpose, at least one means 6 to partly obstruct or shut off the incoming air flow.

The proximal end of the said duct 3c means the end nearest to the wall of the said tank 2; the distal end is the end farthest from the wall of the said tank 2.

“Partly obstructing” means an obstruction or an element that obstructs, divides, partitions or fractions the proximal end of the duct 3c (adapted to cooperate with the orifice 3d of the said tank 2) or an obstruction that fractions the said co-linear duct 3c itself, lengthwise and/or along the height.

The co-linear flow inlet duct 3c may be shut or regulated by at least one adjustable shutting means (not represented but of a type known in itself.

The configuration of at least one of these co-linear inlet ducts 3c comprising at least one partial obstacle means 6 allows the modification of the flow regime and thus the reduction of the height of the mixing apparatus according to the invention by at least 40% in relation to the height of a mixing apparatus of a known type.

The movement of fluid generated by at least one partial obstruction means 6 at the location of at least one co-linear air flow inlet duct 3c with at least another air flow inlet duct 3 that is substantially tangential to the wall of the said tank (and thus perpendicular to the said at least one co-linear inlet duct 3c) leads to at least two sources of fluid rotation inside the tank 2 of mixing apparatus 1, thus improving its air, temperature and homogenous acoustic performance.

The movement of the fluid has a swirling effect, characterised by the existence of at least two poles of rotation. In that way, the stationary swirl structures located near the internal walls of the tank 2 are reduced or degraded.

This phenomenon produced inside the tank 2 is used to optimise the mixing and thermal exchange of the incoming air flows so that the temperature of the outgoing air flows obtained is homogenous, at the same time reducing the volume and size of the tank, and thus the size of the mixing apparatus.

The diameter, section, dimensions and geometry of the said at least one co-linear inlet duct 3c and of the said at least one partial obstruction means 6 are variable and depend on the future arrangement and working of said mixing apparatus 1.

The said at least one co-linear air flow inlet duct 3c comprising the said at least one partial obstruction means 6 is arranged variably, that is to say it may be located on the entire surface of the bottom of the tank 2. In other words, the said at least one means 5 for amplifying fluid mixing may be displaced on the bottom of the tank 2, at the same time being always co-linear with the said tank 2.

Advantageously, the said at least one means 5 for amplifying fluid mixing may also have a variable direction in relation to the central line of the tank 2.

FIGS. 5 and 6 are partial perspective views of an element of the said device according to the invention.

For example, the co-linear air flow inlet ducts 3c may be obstructed partly by a part of its wall, because of their specific geometrical shape or their section or specific end or arrangement or the presence of at least one distinct internal physical element 7 of a type known in itself, which makes it possible to obstruct part of its end.

Alternatively, the said at least one partial obstruction means 6 may be represented in the form of a diaphragm or an internal physical element 7, having a substantially parallelepiped or ovoid shape.

According to another alternative, the said at least one partial obstruction means 6 included in at least one co-linear inlet duct 3c preferably comprises a rectangular section.

Advantageously, a co-linear inlet duct 3c may comprise several sorts of partial obstruction means, i.e. an obstruction or an obstruction means 6 with a section occupying the diameter of the end of the said co-linear duct 3c and/or at least one chord of the duct and/or at least two distinct radial directions (which do not form a diameter, but two quarters, for instance) of the said proximal end or at least any part of the said end or the said co-linear inlet duct 3c itself.

Alternatively, the said at least one partial obstruction means 6 may take the form of a physical element 7 arranged over the entire length and/or entire height and/or section of the said co-linear duct 3c.

The arrangement and number of partial obstructions of the co-linear inlet ducts 3c depend on the required air output and the required size of the device according to the invention.

That configuration of the mixing apparatus according to the invention, comprising at least one axial inlet flow duct 3c with at least one partial obstruction means 6, gives rise, because of the arrangement of the other inlet ducts 3, perpendicular or substantially perpendicular to that duct, to a double rotation pole that interacts with the stationary swirl structures located near the internal walls of the said tank to allow the optimisation of thermal and fluid exchange while reducing the dimensions of the tank.

The terms substantially perpendicular mean that the angular deviation of the said at least one specific inlet duct 3c in relation to the central line of the said tank is of one degree to several tens of degrees.

Further, the mixing apparatus according to the invention makes it possible to adapt it to the constraints of aerospace and/or land transport, particularly in respect of size and acoustics.

Further, the mixing apparatus according to the invention comprising at least one co-linear air flow inlet duct 3c with at least one partial obstruction means 6 makes it possible to reduce the head loss (up to 20%), which leads to energy savings between the inlet and outlet sections of the said tank, and therefore lower supply power. Also, it is less noisy.

Still further, the mixing apparatus 1 makes it possible to reduce the sound power produced in the tank.

Additional ancillary and connected devices may be provided in the tank 2, such as for instance at least one rake and/or turbulence diaphragm (not represented but of a type known in itself.

Alternatively, at least one fan and/or fluid accelerator may be provided at the inlet ducts 3 and/or close to the internal walls of the tank 2 in order to increase the fluid speed.

Further, the fluid and thermal properties remain unchanged if the load at the tank outlet is modified.

The device according to the invention thus enables the conditioning of the air in the aircraft, for instance, while effectively reducing its dimensions and also its mass and the known drawbacks of the prior art of low-pressure air distribution systems in respect of air, temperature, acoustic and power performance.

Advantageously, the quality of the mixtures obtained depends on the obstruction of the said at least one co-linear duct and also the distribution of the speeds between the tangential or substantially tangential inlets and the said at least one co-linear inlet.

Alternatively, the device according to the invention can mix another type of fluid and be used for example in the land transport industry (internal combustion engine) or physics, particularly for heat exchangers.

1. An air flow mixing device (1) made up of a tank (2), having a central line and provided with inlet ducts (3) and outlet ducts (4), arranged so as to create an upward swirling movement of the said fluid inside the said tank in order to ensure homogenous temperature at the outlet, characterised in that the said tank comprises at least one means (5) for amplifying fluid mixing.

2. A mixing device (1) according to claim 1, characterised in that the said at least one amplifying means (5) is arranged on the lower part of the tank (2) so as to be co-linear or substantially co-linear with the central line of the said tank.

3. A mixing device (1) according to claim 1, characterised in that the said at least one amplifying means (5) is at least one inlet duct (3c) comprising at least one means (6) for partially obstructing its proximal end.

4. A mixing device (1) according to the previous claim, characterised in that the said partial obstructing means (6) comprises one part of the wall of the duct (3c) or at least one distinct physical element (7).

5. A mixing device (1) according to the previous claim, characterised in that the said physical element (7) is arranged at the proximal end of the said inlet duct (3c).

6. A mixing device (1) according to claim 4, characterised in that the said physical element (7) is arranged along a diameter and/or a chord and/or at least two distinct radial directions of the proximal end of the said inlet duct (3c).

7. A mixing device (1) according to claim 4, characterised in that the said physical element (7) is arranged over the entire length and/or height of the said duct (3c).

8. A mixing device (1) according to claim 3, characterised in that the said duct (3c) comprises at least one adjustable shutting means.

9. A mixing device (1) according to claim 1, characterised in that the said tank (2) is cylindrical or rectangular or ovoid or spherical or trapezoidal.

10. A mixing device (1) according to claim 1 claims, characterised in that the said tank (2) comprises additional ancillary devices on the inside, such as a rake and/or a diaphragm and/or a fan and/or an accelerator.

11. A mixing device according to claim 1, characterised in that it is used in aeronautics, particularly for aircraft air conditioning, or in land transport, particularly for engines, or in physics, particularly for heat exchangers.
